(19) United States
(12) Patent Application Publication
(10) Pub. No.: US 2014/0172506 A1
(43) Pub. Date: Jun. 19, 2014

(54) CUSTOMER SEGMENTATION

(71) Applicant: MICROSOFT CORPORATION, Redmond, WA (US)

(72) Inventors: RYAN D. PARSELL, LANGLEY, WA (US); JIECHUN WANG, REDMOND, WA (US); CHANDAN KAPOOR, REDMOND, WA (US)

(73) Assignee: MICROSOFT CORPORATION, Redmond, WA (US)

(21) Appl. No.: 13/716,234

(22) Filed: Dec. 17, 2012

(51) Int. Cl. G06Q 30/02

(52) U.S. Cl. CPC G06Q 30/0204
USPC 705/7.33

(57) ABSTRACT

Systems, methods, and products are provided for customer segmentation. Embodiments include offline storage of predetermined segmentation values for customers. Such offline storage typically provides upon request to event processing servers a predetermined segmentation value for a customer. In typical example embodiments, the event processing servers are operatively coupled to the offline storage, and the event processing servers generate, in real time based upon a customer action stream and the predetermined segmentation value, a current segmentation value for the customer. Example embodiments also include online storage operatively coupled to the event processing servers, the online storage receiving from the event processing servers current segmentation values, storing the current segmentation values, and exposing the current segmentation values through an interface for use in servicing customer requests.

### BACKGROUND

Customer segmentation is the practice of dividing a customer base into groups of individuals that are similar in ways relevant to marketing, such as age, gender, interests, spending habits, and so on. Segmentation enables effective targeting of groups of customers and allocation of marketing resources to best effect. Traditional segmentation focuses on identifying customer groups based on demographics and attributes such as attitude and psychological profiles. Customer segmentation can also be value-based, with customers segmented into groups based on revenue generated and the costs of establishing and maintaining customer relationships. Traditional customer segmentation procedures include collecting customer data, integrating data from various sources into a database to which analysis can be applied, and applying methods of analysis to the collected, integrated customer data. Traditional methods of customer data analysis that group customers into segments based upon customer data are computationally intensive, so that traditional methods of customer segmentation are not used to effect segmentation in real time.

### SUMMARY

Example systems, methods, and products are disclosed for customer segmentation. Example embodiments include offline storage that includes storage of predetermined segmentation values for customers. Such offline storage typically provides upon request to event processing servers a predetermined segmentation value for a customer. In typical embodiments, the event processing servers are operatively coupled to the offline storage, and the event processing servers generate, in real time based upon a customer action stream and the predetermined segmentation value, a current segmentation value for the customer. Example embodiments also include online storage operatively coupled to the event processing servers, the online storage receiving from the event processing servers current segmentation values, storing the current segmentation values, and exposing the current segmentation values through an interface for use in servicing customer requests.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 sets forth a block diagram of an example system for customer segmentation.

FIG. 2 sets forth a block diagram of a further example system for customer segmentation.

FIG. 3 sets forth a block diagram of a further example system for customer segmentation.

FIG. 4 sets forth a combination system diagram and data flow diagram illustrating a still further example system for customer segmentation.

FIG. 5 sets forth a flow chart illustrating an example method of customer segmentation.

FIG. 6 sets forth a flow chart illustrating a further method of customer segmentation.

### DETAILED DESCRIPTION OF EXAMPLE EMBODIMENTS

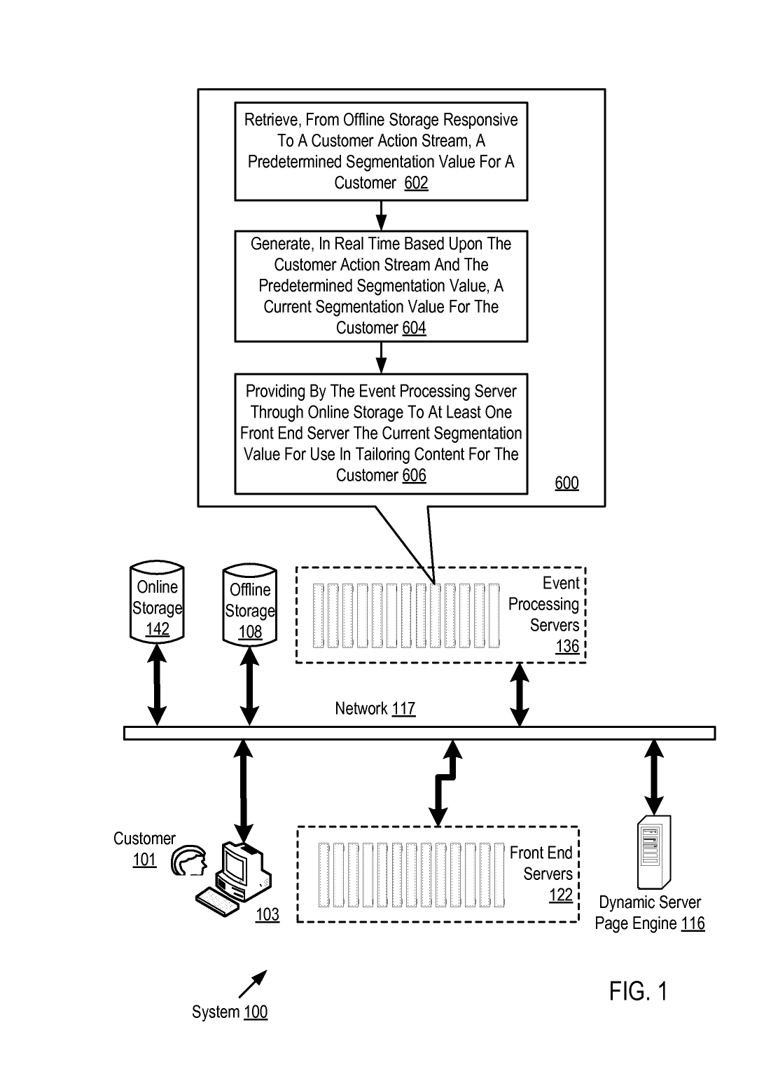

Example methods, systems, and products for customer segmentation are described with reference to the accompanying drawings, beginning with FIG. 1. Customer segmentation is the practice of dividing a customer base into groups of individuals based upon demographics relevant to marketing, such as age, gender, interests, spending habits, and so on. Customer segmentation allows content, such as web pages, to be specifically tailored to a customer based upon that customer's demographics. Customer demographics includes the kind of information that readers will associate with customer profiles, age, gender, occupation, billing information, physical address, and so on. Some customer demographics may be inferred from customer online behavior as evidenced in clickstream data or customer requests for particular websites or other content, interests, spending habits, and the like. In this context, ‘content’ refers to information provided to a customer in response to a customer request, and ‘tailored content’ is content configured according to customer segmentation.

FIG. 1 sets forth a block diagram of an example system (100) for customer segmentation. The system of FIG. 1 uses the combination of a customer's current action stream in an online session and additional information about the a user developed prior to the user's current online session to create in real time a current segmentation value representing the customer's demographics for use in tailoring content for that customer. The system of FIG. 1 includes a client device (103) that allows a customer to access content provided by a number of front end servers (122) through a network (117). Such content accessed by the customer (101) may be in the form of web pages served up by the front end servers (122). In the example of FIG. 1, the content is dynamically generated by a dynamic server page engine (116) in dependence upon a current segmentation value. The current segmentation value is a representation of one or more demographics of the customer embodied in a value and generated in real time. The example dynamic server page engine (116) uses the current segmentation value to dynamically generate content tailored the customer based upon the customer's demographics represented by the current segmentation value.

As mentioned above, the current segmentation value is generated in real time. In the example of FIG. 1, the current segmentation value is generated by one of a plurality of event processing servers (136) based upon a current action stream received from the customer (101) through a client device (130) and an already-generated predetermined segmentation value. The current segmentation value is generated in ‘real time’ in that it is constructed in a time frame or according to a schedule that allows content to be tailored based upon current customer behavior.

A predetermined segmentation value is a segmentation value that is constructed offline and prior to the customers current session with the front end servers (122). The predetermined segmentation value is constructed using data mining techniques against prior customer behavior as indicated by archived customer action streams and other customer demographics such as those available from customer profiles, previous purchases, customer locations, and other customer demographics. Such a predetermined segmentation value may be created in a number of ways through mining prior customer behavior, customer profiles, and any other methods of creating a predetermined segmentation value that will occur to those of skill in the art. The predetermined segmentation value is generated ‘offline’ in that it is constructed in a time frame or according to a schedule that is unrelated to current request/response processing and prior to the current online behavior of the customer. That is, the predetermined segmentation value is generated asynchronously and prior to the customer's current request/response online activity.

Also illustrated in a callout (600) in FIG. 1 is a method of customer segmentation carried out by one or more of the event processing servers (136). In the example of FIG. 1, customer segmentation is carried out by retrieving (602), by at least one event processing server (136) from offline storage (108) responsive to a customer action stream, a predetermined segmentation value for a customer (100). In the example of FIG. 1, customer segmentation also includes generating (604), in real time by the event processing server (136) based upon the customer action stream and the predetermined segmentation value, a current segmentation value for the customer. In this example, customer segmentation also includes providing (606) by the event processing server (136) through online storage (142) to at least one front end server (122) the current segmentation value for use in tailoring content for the customer (100).

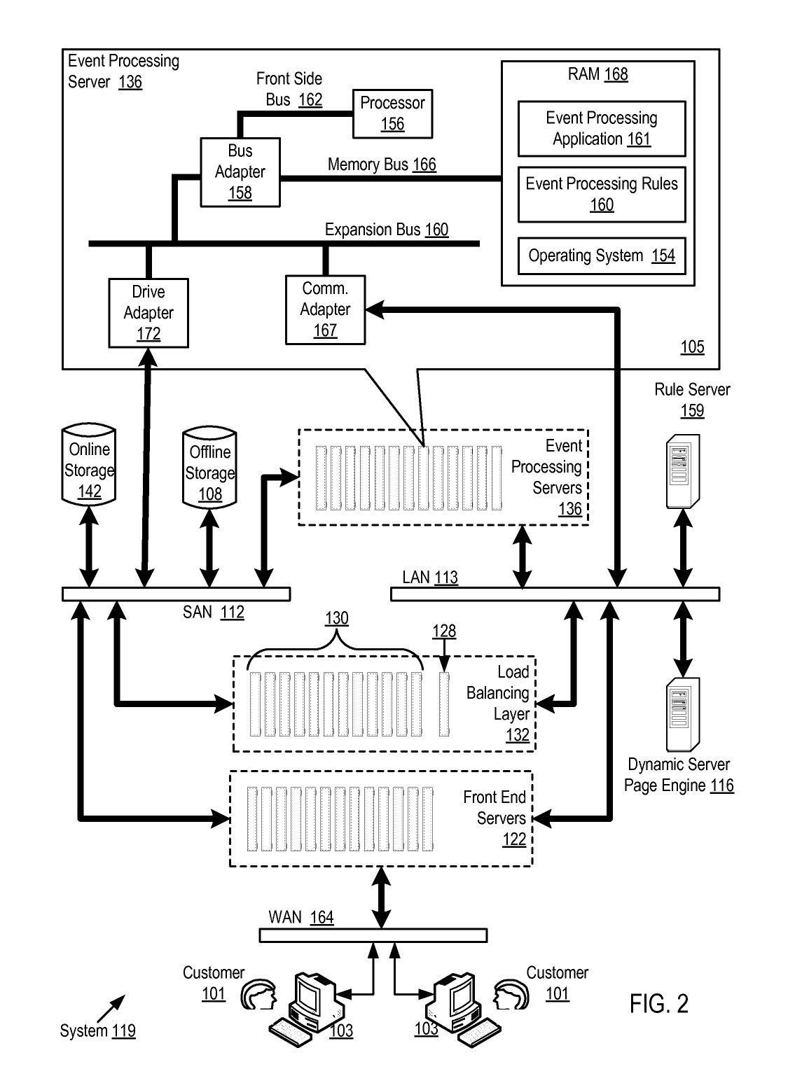

For further explanation, FIG. 2 sets forth a block diagram of a further example system (119) for customer segmentation. The system of FIG. 2 includes a plurality of front end servers (122) operatively coupled for data communications through a wide area network (164) with a number of client devices (103) operated by customers (101). Examples of client devices useful for customer communications with a system for customer segmentation include almost any automated computing machinery that implements data communications, such as, for example, laptop computers, desktop computers, mobile phones, personal digital assistants, tablet computers, and so on. The data communications themselves are carried out through data communications networks, which may be any combination of wired, wireless, optical, or other networks. The front end servers (122) are also operatively coupled for data communications through a local area network (‘LAN’) (113) to a load balancing layer (132), a dynamic server page engine (116), one or more event processing servers (136), a rule server (159), online storage (142), and offline storage (108).

The front end servers (122) of FIG. 2 receive from customers requests for information, that is, for ‘content.’ The front end servers then retrieve from online storage (142) a current segmentation value for a customer, tailor content for presentation to the customer based upon the current segmentation value for the customer, and respond to the customer request with tailored content. The front end servers carry out this tailoring process by providing to the dynamic server page engine (116) a current segmentation value for use in tailoring content responsive to each customer request. The dynamic server page engine (116) dynamically tailors content based upon each current segmentation value by constructing, for example, a dynamic HyperText Markup Language (‘HTML’) page based upon user demographics as represented by the current segmentation value. In some embodiments, content includes applications or other behaviors based on dynamic segmentation. In some such embodiments, content includes JavaScript or variables that dictate how exiting JavaScript will behave given the customers' current segmentation value.

A segmentation value is a data value representing a grouping of customers based upon their demographics, such as age, gender, interests, spending habits, income level, residential location, actual current location, occupation, education level, customer behavior as indicated by customer actions, and other customer demographics. A segmentation value may be represented in any form such as a numeric value, alphanumeric value, binary value, a pointer to a classifier in a table, or in any other form that will occur to those of skill in the art. Two types of segmentation values are used in tailoring content in the system of FIG. 2. The first type of segmentation value is a predetermined segmentation value that is constructed offline using data mining techniques against prior customer behavior as indicated by archived customer action streams and other customer demographics such as those available from customer profiles or any other source of demographics. The predetermined segmentation value is generated ‘offline’ in that it is constructed in a time frame or according to a schedule that is unrelated to current request/response processing. That is, the predetermined segmentation value is generated asynchronously and prior to the customer's current request/response online activity. The second type of segmentation value is a current segmentation value constructed in real time based upon the already generated predetermined segmentation values and current real time customer behavior represented by a customer's current action stream. The current segmentation value is generated in ‘real time’ in that it is constructed in a time frame or according to a schedule that allows content to be tailored based upon current customer behavior.

In the illustrated embodiment, the front end servers (122) are also coupled for data communications with online storage (142) and offline storage (108) through a storage area network (‘SAN’) (112). A SAN is a dedicated network that provides access to consolidated, block level data storage. SANs are primarily used to make storage devices, such as disk arrays and tape libraries, accessible to servers so that each storage device appears to a local operating system as a locally attached device. A SAN typically has its own network of storage devices that are generally not accessible through the local area network by other devices. Most storage networks use the Small Computer System Interface (‘SCSI’) protocol for communication between servers and storage devices. Other supportive data communications infrastructure that can be used to implement a SAN includes Fibre Channel, which is a gigabit-speed network technology widely used to implement SANs, and Infiniband, which is a switched fabric data communications linkage used in high-performance computing and enterprise data centers.

Although the example of FIG. 2 is illustrated with a SAN, workable alternatives to a SAN include many forms of non-volatile data storage, including, for example, file systems or disk drives in any of the servers, Flash drives implemented as electrically erasable programmable read-only memory (‘EEPROMs’), as well as network-attached storage or ‘NAS.’ NAS uses file-based protocols such as Network File System (‘NFS’) or Server Message Block (‘SMB’) or Common Internet File System (‘CIFS’) where it is clear that the storage is remote, and computers and servers request a portion of an abstract file rather than a disk block.

A front end server (122) is a computer server, that operates a request/response data communications protocol, such as, for example, the HyperText Transfer Protocol (‘HTTP’), to accept requests from customers and prepare and return responses. In an embodiment, a front end server is in effect a Web server that forms the front end of a commercial website. The “front end” is formed by the elements of the system (119) that communicates most directly with client devices (103) and customers (101). The front end servers (122) service customer requests and tailor content for the customer based upon segmentation values assigned to that customer.

The front end servers (122) formulate and send to the event processing servers (136) customer action streams (148) composed of indications of customer action for a plurality of customers. A customer action stream is a data stream composed of indications of customer action. Indications of customer action are data elements, such as, for example, contents of HTTP messages, that identify customer actions on client devices, typically indications of invocations by the customer of active elements of a graphical user interface (GUI), including, for example, invocations of elements of touchscreens, invocations of hyperlinks with mouseclicks, opening and closing dialog boxes, clicking a button on a web page, selecting a checkbox, selecting a radio button, and other operations on GUIs. A customer action stream may be composed of information extracted from a rich clickstream, as in, for example, a clickstream provided from client-side scripting in a browser or from other client-side functionality installed on a client device. Alternatively, a customer action stream may be composed of information extracted from as little as a sequence of requests as such, HTTP requests for example, when a clickstream or the like is unavailable.

The front end servers receive customer requests, retrieve from online storage a segmentation value for a customer, and tailor content for presentation to the customer based upon the current segmentation value for the customer. A customer request often takes the form of an HTTP request message issued from a browser on a client device (103) requesting a new web page for display on the client device. The front end servers use a current segmentation value for a customer to dynamically tailor content for that particular customer for presentation to the customer in response to a request from the customer. The front end servers in the example of FIG. 2 use a dynamic server page engine (116) to dynamically tailor content for a particular customer.

A front end server provides a customer's current segmentation value, retrieved from online storage based on a customer identification, logon ID, or the like, to the dynamic server page engine (116), and the dynamic server page engine (116) uses the segmentation value as an input to a process of generating a dynamic web page. The dynamic server page engine (116) implements server-side scripting to vary or ‘tailor’ a dynamically-generated responsive web page based on segmentation values as provided to it by the front end server. The dynamic server page engine (116) can also tailor responses based upon other information such as data in a posted HTML form, parameters in a Uniform Resource Locator ‘URL’, the type of browser being used, the passage of time, or a database or server state. The server-side scripting can be implemented with ASP, ColdFusion, Perl, PHP, WebDNA, and other scripting languages. Such server-side scripting languages may use the Common Gateway Interface (CGI) to produce dynamic web pages. ASP.NET and JSP reuse CGI concepts in their APIs but actually dispatch all web requests into a shared virtual machine. In the illustrated examples, the front end servers and dynamic server page engine are illustrated as separate servers. This is for explanation and not for limitation. In many embodiments, one or more front end servers include dynamic server page engines.

Online storage (142) is ‘online’ in that it is online with respect to the front end servers (122), directly accepting and responding to queries from front end servers (122) for current segmentation values. The current segmentation values stored in online storage are dynamically updated in real time with new segmentation values calculated and provided to online storage (142) by event processing servers (136) operating on live customer action streams. Such dynamic updating is carried out in ‘real time’ in that it is implemented by event processing servers in a time frame or according to a schedule that allows content to be tailored based upon current customer behavior. In contrast, offline storage (108) is ‘offline’ with respect to front end server operations. The predetermined segmentation values in offline storage are generated in a time frame and on a schedule that is unrelated to real time processing of customer requests. Predetermined segmentation values are available to support real time processing, but predetermined segmentation values are not dynamically updated in real time, instead being data mined periodically, less frequently that real time, such as, for example, calculated with an offline run of data mining technology that can take hours instead of the seconds typically associated with dynamic real time operations.

The example system (119) of FIG. 2 includes online storage (142) operatively coupled to the event processing server (136). The online storage (142) receives from the event processing servers (136) current segmentation values (140) for a customer and stores the current segmentation value received from the event processing servers (136). The online storage (142) exposes the current segmentation values through an interface such as an API for use in servicing customer requests. In the system of FIG. 2, the front end servers (122) query the online storage for current segmentation values for customers (101) and the online storage returns the current segmentation values for those customers (101) in response to the queries from the front end servers (122).

The example system (119) of FIG. 2 includes offline storage (108) that includes storage of predetermined segmentation values (112) for customers (101). The offline storage (108) is ‘offline’ with respect to front end server operations. Predetermined segmentation values stored in offline storage (108) are not dynamically updated in real time, but are instead data mined periodically, less frequently than real time, such as, for example, calculated with an offline run of data mining technology that can take hours instead of the seconds typically associated with dynamic real time operations. The offline storage (108) provides upon request to event processing servers (136) a predetermined segmentation value (112) associated with a customer.

The example system (119) of FIG. 2 includes event processing servers (136) operatively coupled to the offline storage (108). Each event processing server (136) generates, in real time based upon a customer action stream (134) and the predetermined segmentation value (112) retrieved from the offline storage (108), a current segmentation value (140) for the customer. ‘Real time’ means that system events affecting responses to customer requests occur within a current session of communications between a customer (101) and the system (119). In an embodiment, known statistical methods are applied to determine average time between customer requests, and the system's load balancing layer (132) and event processing server (136) operations are structured so that current segmentation values are provided within that time frame.

In another embodiment, the system tracks actual time between requests and compares that time to the time required to dynamically generate new current segmentation values, adjusting load balancing to assure that the segmentation value calculation period is smaller than the time between requests. In both examples, the effect is to provide current segmentation values so quickly that content is tailored according to the customer's behavior in a current session, that is, in real time. In non-real-time operations, the effect of the customer's current behavior is not taken into account until after it is stored in offline storage and taken as an input to an offline run of data mining technology, which can take hours rather than seconds.

In some embodiments, generating a current segmentation value (140) in real time includes generating the current segmentation value after a current invocation by the customer of an active element of the GUI and before an immediate next invocation by the customer of a next active element of the GUI. That is, a new current segmentation value is generated in between a customer's invocation of one active element of the GUI and the customer's next invocation of an active element of the GUI. In this way, a current segmentation value is available at each invocation and is updated to include the action streams of the user's last invocation. For further explanation of such example embodiments: In an embodiment with a customer action stream derived from a clickstream, the current segmentation value may be only one mouseclick behind, that is, it may be calculated and made available for online processing of customer requests between mouseclicks or in between other invocations of a GUI such as the invocation of a touchscreen control. In an embodiment with a customer action stream derived from customer requests, the current segmentation value may be calculated and made available for online processing between requests.

The current segmentation values for the customer are generated by the event processing servers (136) in real time based upon the current customer action stream provided by the front end servers (122) and predetermined segmentation values that have been calculated offline and provided by the offline storage (108). The current segmentation values are generated by the event processing servers (136) according to rules stored in the rule server (159). The rule server (159) stores and publishes event processing rules. The event processing servers (136) query the rule server periodically to refresh sets of event processing rules maintained in each event processing server. A processing rule instructs an event processing server (136) as to which actions to search for in a customer action stream (134), which values to search for among predetermined segmentation values (112), and how to associate them together to generate the current segmentation values (140). In an embodiment, each event processing rule corresponds to one current segmentation value, defining how to calculate that current segmentation value based upon corresponding elements from a customer action stream and corresponding predetermined segmentation values. Such event processing rules as stored in a rule server (159) may be established and updated periodically by, for example, a system administrator.

The example system (119) of FIG. 2 also includes a load balancing layer (132) that includes at least one load balancing server (128) and a number of stateless partitioning servers (130). The load balancing server (128) is operatively coupled to the front end servers (122) and to the plurality of stateless partitioning servers (130). The load balancing server receives from the front end servers (122) a number of customer action streams and divides the action streams among the partitioning servers. The partitioning servers divide a number of balanced action streams based upon identifications of the customers, and direct the divided actions streams to a number of event processing servers (136). In this way, an event processing server generates current segmentation values for a particular customer.

For further explanation of the example of FIG. 2, a callout (105) illustrates example components of an event processing server (136). The callout (105) is used to illustrate components of servers generally and each of the servers of FIG. 2 may include the same or similar components. The event processing server (136) of FIG. 2 includes a computer processor (156) or ‘CPU’ as well as random access memory (168) (‘RAM’) which is connected through a high speed memory bus (166) and bus adapter (158) to processor (156) and to other components of the computer (152). Stored in RAM (168) is an operating system (154). Operating systems useful in embodiments for customer segmentation include UNIX™, Linux™, Microsoft Windows™, AIX™, IBM's i5/OS™, and others as will occur to those of skill in the art.

Also stored in RAM (168) is an event processing application (161) and processing event processing rules (160). An event processing application, is a module of computer program instructions for customer segmentation that when executed retrieve, from offline storage (108) responsive to a customer action stream, a predetermined segmentation value for a customer (101); generate, in real time based upon the customer action stream, the predetermined segmentation value and event processing rules (160), a current segmentation value for the customer; and provide through online storage (142) to a front end server (122) the current segmentation value for use in tailoring content for the customer.

The operating system (154), the event processing rules (160), and the event processing application (161) in the example of FIG. 2 are shown in RAM (168), but many components of such software typically are stored in non-volatile memory also, such as, for example, on a disk drive or in memory on the SAN (112). That is, at any given time, only a portion of one or more of the programs depicted in RAM in FIG. 2 may be resident in RAM.

The event processing server (136) of FIG. 2 includes disk drive adapter (172) coupled through expansion bus (160) and bus adapter (158) to processor (156) and other components of the event processing server (136). The disk drive adapter (172) is operatively coupled with the SAN (112) to connect the event processing server to non-volatile data storage in the form of online storage (142) and offline storage (108). Disk drive adapters useful in computers for customer segmentation include Small Computer System Interface (‘SCSI’) adapters, Fibre Channel adapters, Integrated Drive Electronics (‘IDE’) adapters, and others as will occur to those of skill in the art.

The event processing server (136) of FIG. 2 includes a communications adapter (167) for data communications with other computers such as the servers in the load balancing layer (132), the rule server (159), the front end servers (122), and other event processing servers (136). The communications adapter (167) also provides data communications through networks such as the LAN (113) of FIG. 2. Such data communications may be carried out serially through RS-232 connections, through external buses such as a Universal Serial Bus (‘USB’), through data communications networks such as Internet Protocol or ‘IP’ data communications networks, and in other ways as will occur to those of skill in the art. Communications adapters implement the hardware level of data communications through which one computer sends data communications to another computer, directly or through a data communications network. Examples of communications adapters useful for customer segmentation include modems for wired dial-up communications, Ethernet (IEEE 802.3) adapters for wired data communications network communications, and 802.11 adapters for wireless data communications network communications.

The arrangement of servers and other devices making up the example system illustrated in FIG. 2 are for explanation, and not for limitation. Data processing systems useful in various embodiments may include additional servers, routers, other devices, and peer-to-peer architectures, not shown in FIG. 2, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments may be implemented on a variety of hardware platforms in addition to those illustrated in FIG. 2.

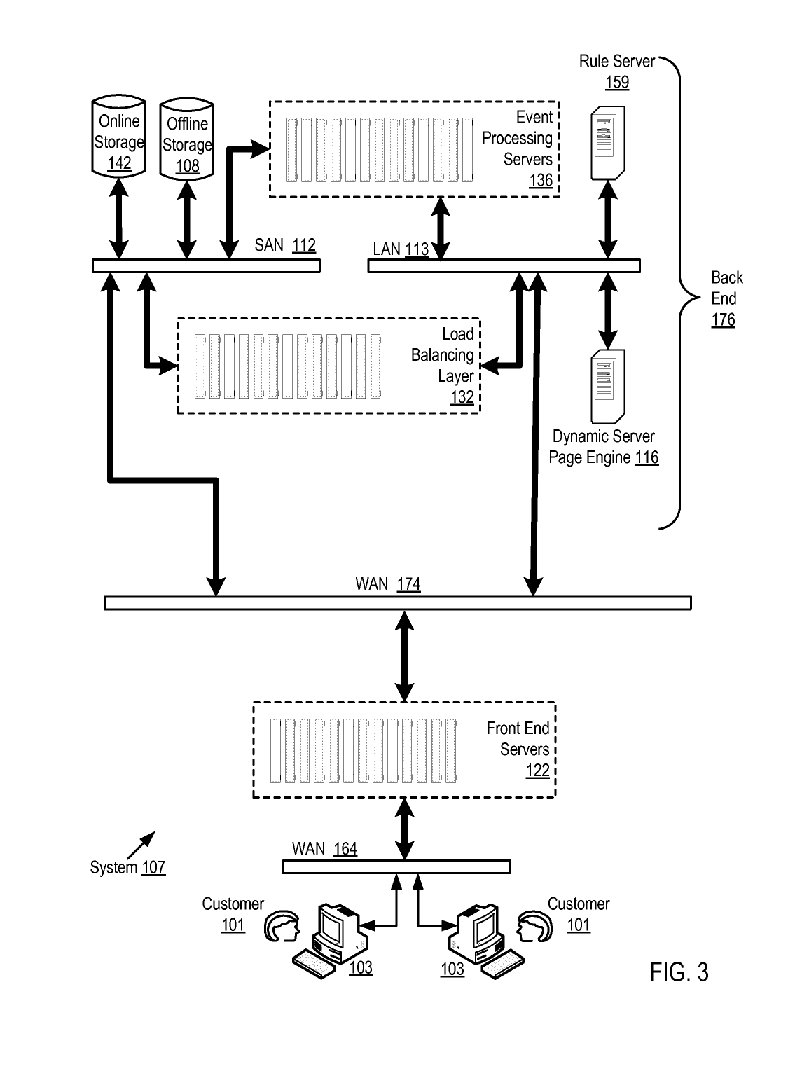

For further explanation, FIG. 3 sets forth a block diagram of a further example system (107) for customer segmentation. The example system (107) of FIG. 3 is similar to the example of FIG. 1 in that the system of FIG. 3 includes front end servers (122), a load balancing layer (132), event processing servers (136), online storage (142), offline storage (108), a rule server, and a dynamic server page engine (116), all of which are structured and operate in a similar fashion as described above with reference to FIG. 1.

The example of FIG. 3 illustrates a somewhat different overall architecture than the example of FIG. 1. In the example system of FIG. 3, the front end servers (122) are operatively coupled for data communications through a WAN (174) to system components characterized as a back end (176). The components of the back end (176) include the load balancing layer (132), the event processing servers (136), the online storage (142), the offline storage (108), the rule server (159), and the dynamic server page engine (116). In comparison with the architecture of FIG. 1, the overall architecture of the example of FIG. 3 provides an additional network coupling (174) that represents an additional layer of data communications that supports separate ownership and operation of the front end and the back end. That is, in the system of FIG. 3 one entity may own and operate the front end servers (122) and another completely separate entity may own and operate the back end (176). The system of FIG. 3 allows an operator of a website, for example, to provide high-speed tailored content based upon current segmentation values provided by the operator of the back end—with no need for the owner/operator of the front end to incur the expense and difficulty of establishing and running its own back end.

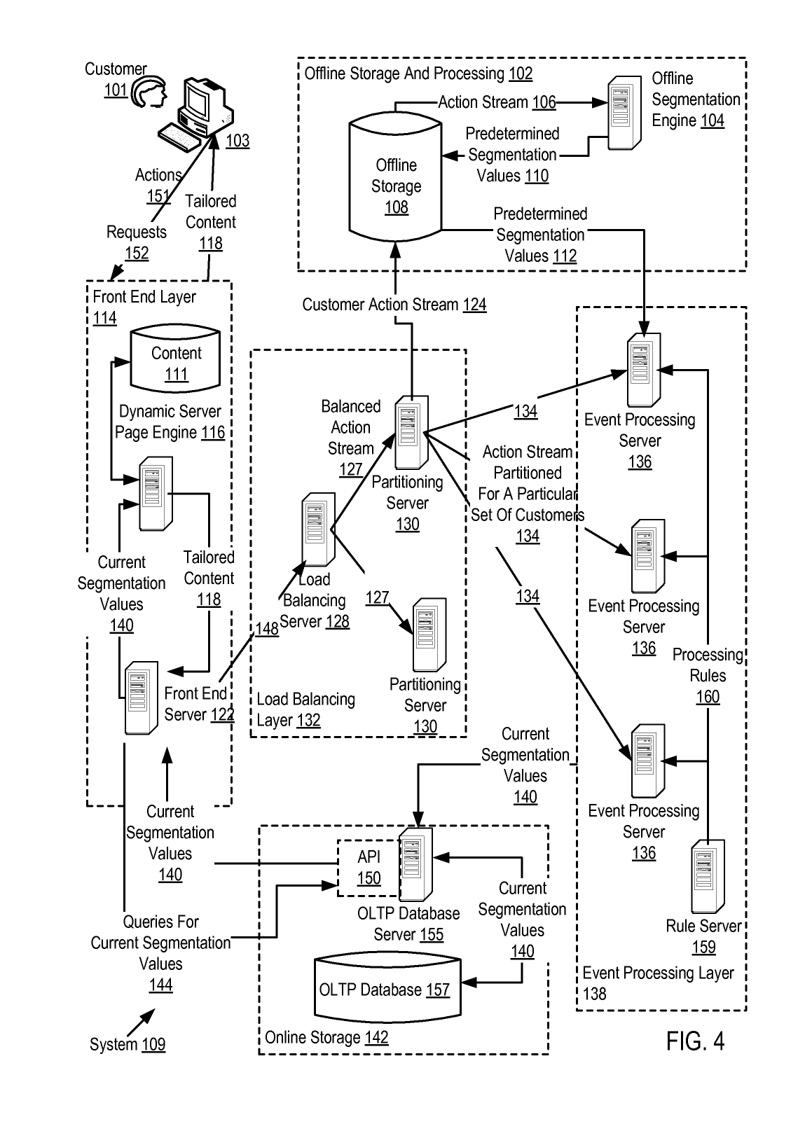

For further explanation, FIG. 4 sets forth a combination system diagram and data flow diagram illustrating a still further example system (109) for customer segmentation. The example system (109) of FIG. 4 has a similar overall structure or architecture as the examples of FIGS. 1 and 2, including a front end layer (114) that includes a plurality of front end servers (122) and a dynamic server page engine (116), with the front end servers (122) operatively coupled for data communications through networks to online storage (142). In the example of FIG. 4, the front end servers are characterized as forming a front end layer (114) of the system architecture, the front end layer having several front end servers (122), although readers will recognize that such a front end layer in many embodiments will be composed of many front end servers.

In the example of FIG. 4, the front end servers are operatively coupled for data communications to online storage (142), which in turn is operatively coupled to event processing servers (136). The online storage (142) includes an online transaction processing (‘OLTP’) database server (155). Online transaction processing (‘OLTP’) refers to a class of database management systems that facilitate and manage transaction-oriented database applications, typically for data entry and retrieval database transaction processing. OLTP often refers to processing in which the database management system responds immediately to requests. The OLTP database server maintains a database (157) of current segmentation values (140). The OLTP database server receives current segmentation values (140) from event processing servers (136), where the current segmentation values are generated, and stores the current segmentation values in the OLTP database (157). The OLTP database server updates periodically the current segmentation values in the database (157) of current segmentation values, and provides current segmentation values for use in servicing customer requests. The online transaction processing database server exposes an interface (150) to the front end servers (122), accepts queries (144) for current segmentation values for customers from the front end servers (122) and returns current segmentation values (140) for the customers in response to the queries from the front end servers (122).

The front end servers (122) in the front end layer (114) of FIG. 4 receive customer requests (152) from a client device (103) operated by a customer (101) and respond to such requests with tailored content (118) that is custom tailored for each customer according to each customer's current segmentation value. That is, the front end servers (122) tailor content for presentation to each customer based upon a current segmentation value (140) for each customer. Upon receiving a customer request, a front end server retrieves from online storage (142) a segmentation value (140) for the customer. In the example of FIG. 4, the front end servers (122) retrieve from online storage (142) current segmentation values (140) by calling through an application programming interface (‘API’) to an API exposed by an OLTP database server (155), sending queries (144) for current segmentation values. The front end servers (122) tailor content by providing the current segmentation values (140) to a dynamic server page engine (116) and receiving from the dynamic server page engine tailored content (118) generated by the dynamic server page engine (116). The front end servers (122) then return the tailored content (118) to the client device (103) of the customer (101).

The customer requests (152) are requests for information. Often in such a system, the information or content requested is a web page, an HTML document for display through a customer browser on a client device (103), and the customer request (152) typically is expressed in the form of an HTTP request message. The HTML documents, the web pages provided in response to customer requests are dynamically generated rather than statically stored. The custom tailoring in the example of FIG. 4, reflecting the ubiquity of HTTP and HTML, is carried out by a dynamic server page engine (116) that generates a dynamic web page with content selected by server-side scripting based upon a customer's current segmentation value. The content in this example is stored in a content database (111) that contains items of content each of which is associated in storage with a current segmentation value. The dynamic server page engine uses a current segmentation value as provided to it by a front end server to lookup in the content database content associated with that current segmentation value and dynamically insert that content into an HTML document for return to a requesting customer.

The front end servers (122) of FIG. 4 are operatively coupled for data communications to a load balancing layer (132) that includes a load balancing server (128) and a plurality of stateless partitioning servers (130). The front end servers (122) formulate and send to the load balancing layer (132) customer action streams (148) composed of indications of customer action for a number of customers, in fact, in many embodiments, a large number of customers. A customer action stream is a data stream composed of indications of customer action. The example of FIG. 4 indicates both customer requests (152) and customer actions (151) flowing from the customer to the front end layer and therefore the front end servers. Of course a customer request can be viewed as a kind of customer action, and indications of customer requests typically are included in the formulation of a customer action stream. But the indications of customer action (151) available for inclusion in customer action streams are broader than requests as such, including, for example, general clickstream data, mouseclicks, opening and closing dialog boxes, clicking a button on a web page, selecting a checkbox, selecting a radio button, and other operations on GUIs.

The load balancing server receives from the front end servers (122) a number of action streams (148) for customers and divides the action streams among the partitioning servers. The customer action streams so divided are referred to in the example of FIG. 4 as balanced action streams (127) because the load balancing server, in dividing the streams among the partitioning servers, operates at least in some fashion to apportion the streams among the partitioning servers. The load balancing server (128) can divide the customer action streams (148) among the partitioning servers in a variety of ways, including, for example, dividing the streams evenly according to the number of partitioning servers (130) presently deployed in the load balancing layer. In the particular example of FIG. 4, only two partitioning servers (130) are deployed in the load balancing layer (130), but readers will appreciate that any number of partitioning servers can be so deployed, and that the number of partitioning servers can vary dynamically according to overall data processing load in a segmentation system (109).

The partitioning servers (130) are ‘stateless’ in the sense that they maintain no state-related information regarding sessions of customer communications, for example, customer communications with the front end servers (122), which in commercial embodiments may maintain a large quantity of state information regarding customer communications, logon credentials, shopping cart contents, time online, security status, session identification, request processing status, and so on. In contrast, the partitioning servers (130) merely pass through the customer action streams (127) that are directed to the partitioning servers without retaining information regarding the state of those streams.

The stateless partitioning servers (130) direct (124) the divided action streams (127) to offline storage (108) for offline segmentation processing (104). Offline storage (108) is data storage of predetermined segmentation values (112) for customers (101). The offline storage (108) provides upon request to an event processing server (136) a predetermined segmentation value (112) for a customer. The offline segmentation processing is carried out by an offline segmentation engine (104) that uses known data mining technology to calculate predetermined segmentation values for each customer based upon each customer's action streams and other demographic information. The predetermined segmentation values are ‘predetermined’ in that they are calculated, not in real time in response to requests from event processing servers, but prior to any requests for them from event processing servers, so that the predetermined values are immediately available upon request. The offline segmentation processing is ‘offline’ in that it is conducted asynchronously and prior in time with respect to current processing in the event processing servers. That is, the offline segmentation processing is ‘offline’ in that its actual processing operations are decoupled from the present real time calculations carried out by event processing servers and the OLTP database server. Predetermined segmentation values are not dynamically updated in real time, but are instead data mined periodically, less frequently that in real time, such as, for example, calculated with a midnight run of data mining technology that can take hours instead of the seconds typically associated with dynamic real time operations. These predetermined segmentation values are then available for use by the event processing servers in real time calculations of current segmentation values based upon, not only historical action streams, but also upon current customer action streams presently flowing from the load balancing layer into the event processing servers (136).

The event processing servers (136) are operatively coupled for data communications both to the partitioning servers and to the offline storage (108). The event processing servers (136) generate, in real time based upon customer action streams (134) and predetermined segmentation values (112), a current segmentation value (140) for each customer whose actions are depicted in a current action stream. In addition to directing customer action streams to the offline storage for offline segmentation processing, the partitioning servers divide a number of balanced action streams (127) based upon identifications of the customers, and direct the action streams to a number of event processing servers (136). Each action stream bears a customer identification. In directing the divided action streams based upon the identifications of customers, the partitioning servers direct customer action streams to the event processing servers effectively partitioned for a particular set of customers, with all indications of customer action for a particular customer flowing always to the same event processing server. In this way, each event processing server can generate in real time a current segmentation value for each customer whose action stream is directed to that event processing server, because that event processing server possesses all current event information for that customer.

In an embodiment, generating a current segmentation value (140) in real time is carried out by generating the current segmentation value after a current invocation by the customer of an active element of the GUI and before an immediate next invocation by the customer of a next active element of the GUI. In this way, a current segmentation value for a customer, currently available for use in tailoring content by the time the customer's next request is received, is based upon the very latest action information available for the customer, the customer's very last keystroke, very last mouseclick on a hyperlink, or very last request for content, for example.

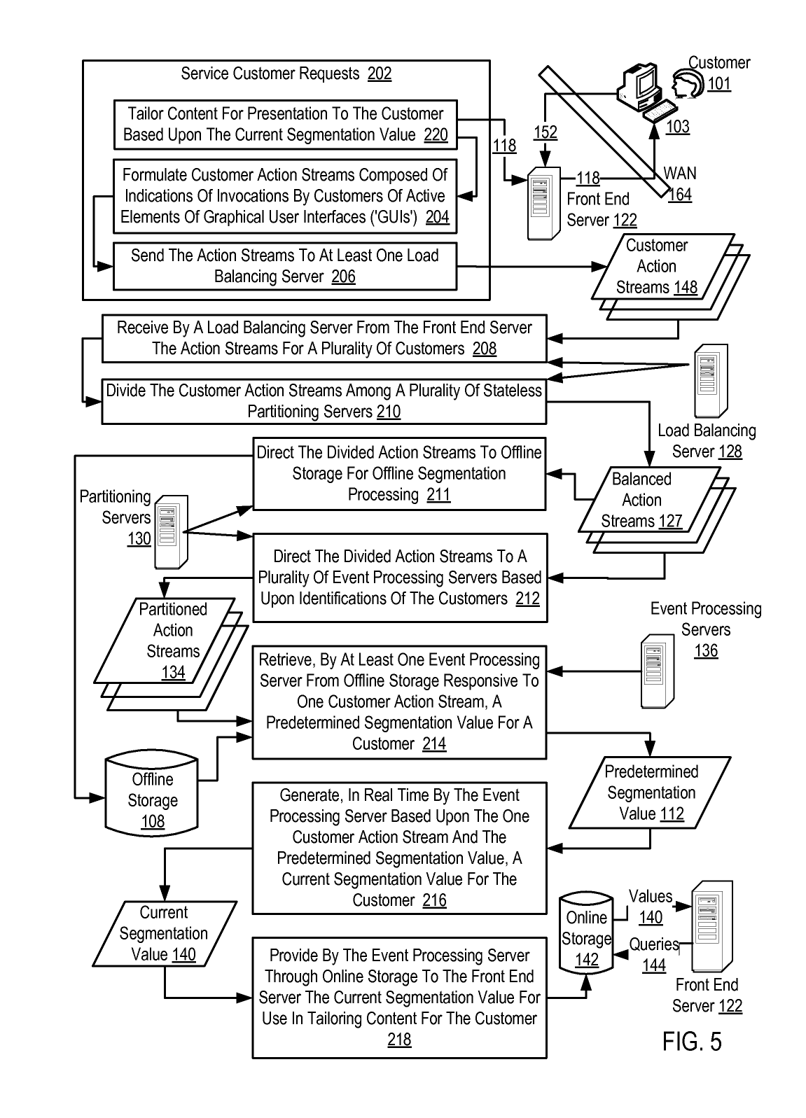

For further explanation, FIG. 5 sets forth a flow chart illustrating an example method of customer segmentation. Embodiments of this method typically are implemented on automated systems for customer segmentation similar to those described above with reference to FIGS. 1, 2, and 3. The method of FIG. 5 begins with servicing (202) by a front end server (122) of customer requests. In the method of FIG. 5, servicing (202) customer requests includes tailoring content (220) for presentation to a customer based upon a current segmentation value (140). That is, in servicing a customer request, a front end server (122) receives a request (152) communicated across a network (164) from a customer client device (103); dynamically constructs, based upon a current segmentation value (140) for the customer, tailored content (118) for response to the request; and transmits the tailored content (118) back across a network to the customer's client device (103). The client device (103) and the front end server (122) are on different sides of a client-server divide in a client-server architecture. It is the client device (103) that carries out the actual presentation of tailored content to the customer. The step of tailoring content (220) is therefore said to be ‘for’ presentation, a description of purpose, not a description of actual presentation from the server side. The process of tailoring content (220) is entirely completed by the time the front end server (122) places the tailored content (118) on the network (164) for transmission to the customer's client device (103). Indeed in this sense, the overall process of servicing (202) a customer request (152) is entirely completed, for any particular request, by the time a front end server (122) places tailored content (118) responsive to the request on a network (164) for transmission to a customer's client device (103).

In the method of FIG. 5, servicing (202) customer requests also includes formulating (204) customer action streams (148) composed of indications of invocations by customers of active elements of graphical user interfaces (‘GUIs’) and sending (206) the action streams to a load balancing server (128). The load balancing server (128) receives (208) from the front end server (122) the action streams (148) for a plurality of customers. The load balancing server (128) also divides (210) the customer action streams (148) among a number of stateless partitioning servers (130). The stateless partitioning servers (130) direct (211) the divided action streams (127) to offline storage (108) for offline segmentation processing. Offline segmentation processing is carried out by an offline segmentation engine (e.g., 104 on FIG. 3) that uses known data mining technology to calculate predetermined segmentation values for customers based upon customers' action streams (124). The predetermined segmentation values are ‘predetermined’ in that they are calculated, not in real time in response to requests from event processing servers, but prior to any requests for them from event processing servers, so that the predetermined values are immediately available upon request. The offline segmentation processing is ‘offline’ in that it is conducted asynchronously and prior in time with respect to current processing in the event processing servers.

The method of FIG. 5 also includes directing (212) the divided action streams (127) by the stateless partitioning servers (130) to a plurality of event processing servers (136) based upon identifications of the customers. According to the method of FIG. 5, an event processing server (136), responsive to one customer action stream (134), retrieves (214) from offline storage (108) a predetermined segmentation value (112) for a customer (101), that is, for the customer identified with the particular action stream. The event processing server (136) generates (216), in real time based upon the one customer action stream (134) and the predetermined segmentation value (112), a current segmentation value (140) for the customer.

The event processing server (136) provides (218) through online storage (142) to the front end server (122) the current segmentation value (140) for use in tailoring content for the customer. Because front end servers take action, that is, issue queries (144) to the online storage facility, in order to obtain current segmentation values (140), the current segmentation values are considered to have been provided to the front end servers as soon as they are stored in online storage.

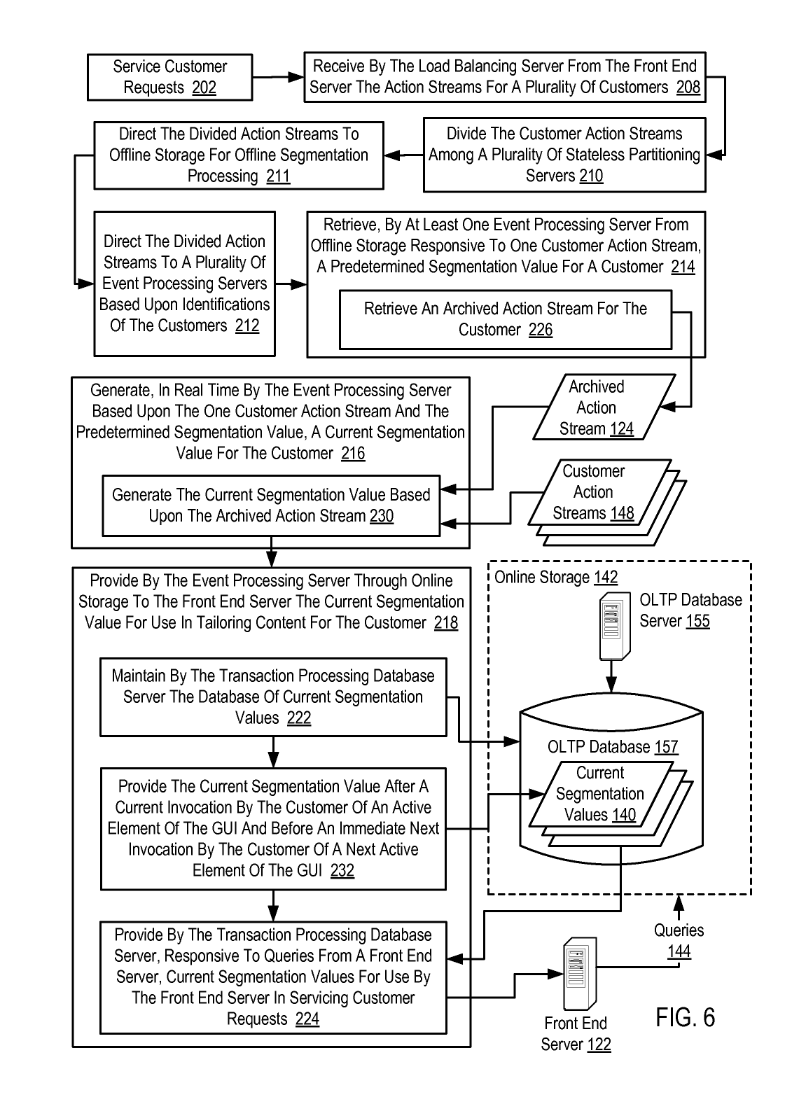

For further explanation, FIG. 6 sets forth a flow chart illustrating a further method of customer segmentation. The method of FIG. 6 is similar to the method of FIG. 4 in that it includes a front end server's servicing (202) customer requests; a load balancing server's (128) receiving (208) from a front end server (122) the action streams (148) for a plurality of customers; dividing (210) the customer action streams (148) among a plurality of stateless partitioning servers (130); directing (211) the divided action streams (127) from the stateless partitioning servers (130) to offline storage (108) for offline segmentation processing; directing (212) the divided action streams (127) to event processing servers (136) based upon identifications of the customers; retrieving (214) from offline storage (108) responsive to one customer action stream (134), a predetermined segmentation value (112) for a customer (101); an event processing server's generating (216), in real time based upon the one customer action stream (134) and the predetermined segmentation value (112), a current segmentation value (140) for the customer; and providing (218) the current segmentation value (140) through online storage to the front end server (122) for use in tailoring content for the customer.

In the method of FIG. 6, the online storage (142) includes an online transaction processing database server (155) and a database (157) of current segmentation values (140). In the method of FIG. 6, providing (218) the current segmentation value includes maintaining (222) by the transaction processing database server the database of current segmentation values (140) and providing (224) by the transaction processing database server, responsive to queries (144) from a front end server (122), current segmentation values (140) for use by the front end server in servicing customer requests.

In the method of FIG. 6, retrieving (226) a predetermined segmentation value for the customer includes retrieving an archived action stream (124) for the customer. An archived action stream (124) is a previous action stream of a customer, often an action stream of a previous session with the customer, that is stored in offline storage. In the example of FIG. 6, generating (216) a current segmentation value includes generating (230) the current segmentation value based upon the archived action stream (124) and the current action stream (148). Generating (230) the current segmentation value based upon the archived action stream (124) and the current action stream (148) in the method of FIG. 6 is carried out according to event processing rules that accommodate both archived action streams and current action streams.

In the method of FIG. 6, the customer action streams (148) are composed of indications of invocations by the customer of active elements of a graphical user interface (GUI), and providing (218) the current segmentation value includes providing (232) the current segmentation value after a current invocation by the customer of an active element of the GUI and before an immediate next invocation by the customer of a next active element of the GUI. In this way, a current segmentation value is available at each invocation and is updated in ‘real time’ to include indications from an action stream of the user's last invocation, the user's last mouseclick or request, for example.

Example embodiments of customer segmentation are described largely in the context of a fully functional computer system for customer segmentation. Readers will recognize, however, that customer segmentation also may be implemented in a computer program product disposed upon computer readable storage media for use with any suitable data processing system. Such computer readable storage media may be any storage medium for machine-readable information, including magnetic media, optical media, or other suitable storage media. Examples of such media include magnetic disks in hard drives or diskettes, compact disks for optical drives, magnetic tape, and others as will occur to those of skill in the art. Such computer readable storage media are distinguished from communications media, such as signals as such, which are embodied for example on a network. Persons skilled in the art will immediately recognize that any computer system having suitable programming means will be capable of executing a method of customer segmentation as embodied in a computer program product. Persons skilled in the art will recognize also that, although some of the example embodiments described in this specification are oriented to software installed and executing on computer hardware, nevertheless, alternative embodiments of customer segmentation may be implemented as firmware or entirely as hardware.

It will be understood from the foregoing descriptions of example embodiments that modifications and changes may be made in various embodiments for customer segmentation. The descriptions in this specification are for purposes of illustration only and are not to be construed in a limiting sense.

What is claimed is:

1. A system for customer segmentation comprising:
offline storage comprising storage of predetermined segmentation values for customers, the offline storage providing upon request to at least one event processing server a predetermined segmentation value for a customer;
the at least one event processing server operatively coupled to the offline storage, the event processing server generating, in real time based upon a customer action stream and the predetermined segmentation value, a current segmentation value for the customer; and
online storage operatively coupled to the event processing server, the online storage receiving from the event processing server the current segmentation value, storing the current segmentation value, and exposing the current segmentation value through an interface for use in servicing customer requests.

2. The system of claim 1 further comprising at least one front end server operatively coupled to the event processing server, the front end server formulating and sending to the event processing server customer action streams composed of indications of customer action for a plurality of customers.

3. The system of claim 1 further comprising a front end server operatively coupled to the online storage, the front end server receiving customer requests, retrieving from online storage a segmentation value for each customer, and tailoring content for presentation to each customer based upon the current segmentation value for each customer.

4. The system of claim 1 wherein the online storage further comprises an online transaction processing database server, the online transaction processing database server maintaining a database of current segmentation values, updating current segmentation values in the database of current segmentation values, and providing current segmentation values for use in servicing customer requests.

5. The system of claim 1 wherein:
the customer action stream includes indications of invocations by the customer of active elements of a graphical user interface (‘GUI’); and
generating a current segmentation value in real time comprises generating the current segmentation value after a current invocation by the customer of an active element of the GUI and before an immediate next invocation by the customer of a next active element of the GUI.

6. The system of claim 1 further comprising:
a load balancing server operatively coupled to a front end server and to a plurality of stateless partitioning servers, the load balancing server receiving from the front end server a plurality of action streams for a plurality of customers and dividing the action streams among the partitioning servers; and
the plurality of stateless partitioning servers operatively coupled to the load balancing server, the partitioning servers directing the divided action streams to a plurality of event processing servers based upon identifications of the customers.

7. The system of claim 1 further comprising a rule server storing and publishing to the event processing server event processing rules for use in generating a current segmentation value for the customer.

8. A method of customer segmentation comprising:
retrieving, by at least one event processing server from offline storage responsive to a customer action stream, a predetermined segmentation value for a customer;
generating, in real time by the event processing server based upon the customer action stream and the predetermined segmentation value, a current segmentation value for the customer; and
providing by the event processing server through online storage to at least one front end server the current segmentation value for use in tailoring content for the customer.

9. The method of claim 8 further comprising servicing customer requests by the front end server, including:
formulating by the front end server customer action streams composed of indications of invocations by customers of active elements of graphical user interfaces (‘GUIs’); and
sending by the front end server the action streams to the event processing server.

10. The method of claim 8 further comprising servicing by the front end server one or more customer requests for the customer, including tailoring content for presentation to the customer based upon the current segmentation value.

11. The method of claim 8 wherein the online storage comprises an online transaction processing database server and a database of current segmentation values, and providing the current segmentation value further comprises:
maintaining by the transaction processing database server the database of current segmentation values; and
providing by the transaction processing database server, responsive to queries from a front end server, current segmentation values for use by the front end server in servicing customer requests.

12. The method of claim 8 wherein:
retrieving a predetermined segmentation value for the customer further comprises retrieving an archived action stream for the customer; and
generating a current segmentation value further comprises generating the current segmentation value based upon the archived action stream.

13. The method of claim 8 wherein:
the customer action stream includes indications of invocations by the customer of active elements of a graphical user interface (‘GUI’); and
providing the current segmentation value further comprises providing the current segmentation value after a current invocation by the customer of an active element of the GUI and before an immediate next invocation by the customer of a next active element of the GUI.

14. The method of claim 8 further comprising:
receiving by a load balancing server from a front end server a plurality of action streams for a plurality of customers;
dividing by the load balancing server the customer action streams among a plurality of stateless partitioning servers; and
directing the divided action streams by the stateless partitioning servers to a plurality of event processing servers based upon identifications of the customers.

15. The method of claim 8 further comprising:
receiving by a load balancing server from a front end server a plurality of customer action streams for a plurality of customers;
dividing by the load balancing server the customer action streams among a plurality of stateless partitioning servers; and
directing the divided action streams by the stateless partitioning servers to offline storage for offline segmentation processing.

16. A computer program product for customer segmentation, the computer program product disposed upon one or more computer storage media, the computer program product comprising computer program instructions that, when executed, cause one or more servers to carry out the steps of:
servicing by a front end server customer requests, including formulating customer action streams composed of indications of invocations by customers of active elements of graphical user interfaces (GUIs), and sending the action streams to at least one load balancing server;
receiving by the load balancing server from the front end server the action streams for a plurality of customers;
dividing by the load balancing server the customer action streams among a plurality of stateless partitioning servers;
directing the divided action streams by the stateless partitioning servers to a plurality of event processing servers based upon identifications of the customers;
retrieving, by at least one event processing server from offline storage responsive to one customer action stream, a predetermined segmentation value for a customer;
generating, in real time by the event processing server based upon the one customer action stream and the predetermined segmentation value, a current segmentation value for the customer; and
providing by the event processing server through online storage to the front end server the current segmentation value for use in tailoring content for the customer.

17. The computer program product of claim 16 further comprising computer program instructions that, when executed, cause the front end server to carry out the step of servicing one or more customer requests for the customer, including tailoring content for presentation to the customer based upon the current segmentation value.

18. The computer program product of claim 16 wherein the online storage comprises an online transaction processing database server and a database of current segmentation values, and the computer program product further comprises computer program instructions that, when executed, cause transaction processing database server to carry out the steps of:
maintaining the database of current segmentation values; and
providing, responsive to queries from a front end server, current segmentation values for use by the front end server in servicing customer requests.

19. The computer program product of claim 16 wherein:
retrieving a predetermined segmentation value for the customer further comprises retrieving an archived action stream for the customer; and
generating a current segmentation value further comprises generating the current segmentation value based upon the archived action stream.

20. The computer program product of claim 16 wherein providing the current segmentation value further comprises providing the current segmentation value after a current invocation by the customer of an active element of the GUI and before an immediate next invocation by the customer of a next active element of the GUI.
